(19) United States
(12) Patent Application Publication
(10) Pub. No.: US 2004/0128033 A1
(43) Pub. Date: Jul. 1, 2004

(54) Embedded internet integrated chip controlled valve actuator

(75) Inventors: Chia-Lin Ku, Pan-Chiau City (TW); Chin-Shun Lin, Ying-Ge Chen (TW)

Correspondence Address: SENNIGER POWERS LEAVITT AND ROEDEL, ONE METROPOLITAN SQUARE, 16TH FLOOR, ST LOUIS, MO, 63102, US

(73) Assignee: Metal Industries Research & Development Centre

(21) Appl. No.: 10/441,467

(22) Filed: May 20, 2003

(30) Foreign Application Priority Data
Dec. 30, 2002 (TW) 091137850

(51) Int. Cl. G05D 7/00

(52) U.S. Cl. 700/282

(57) ABSTRACT

The present invention provides a valve actuator with an embedded integrated chip. Said valve actuator can be connected directly to the Internet so as to achieve the object of dispersed controlling.

### BACKGROUND OF THE INVENTION

1. Field of the Invention

The present invention relates to a valve actuator, more specifically, the present invention relates to a valve actuator controlled by an embedded Internet integrated chip controller.

2. Related Art

In the field of industrial process control, there are three most commonly used automatic control modes: being controlled by a programmable logic circuit, by a single chip and by a computer. The object of controlling peripheral apparatuses through a computer is achieved by way of said three automatic control modes. The conventional industrial control valve actuator generally uses the design of 4 to 20 mA analog signal. 4 mA represents 0 calibration; in other words, the valve is closed completely. 20 mA represents full calibration; in other words, the valve is open completely.

The conventional industrial control valve actuators generally use dual twisted lines as signal transmission lines and transmit with analog voltage or current signal. However, dual twisted lines suffer environmental interference easily in long distance remote control, which decays the response time and transmission signal and affects the control quality.

In the field of industrial control, there are two commonly used communication methods, RS-485 and RS-232. RS-485 communication is to receive and transmit output control signals in a small dispersed control system. RS-485 uses half dual mode and only needs a pair of differential signal lines. The disadvantage of said communication method is that no node can have two or more to transmit outside simultaneously, otherwise the signals will overlap and affect the process of communication. RS-232 communication uses a serial communication port. In general, COM 1 and COM 2 channels of a computer are designed to communicate in RS-232 communication method. The disadvantages of said communication method are that it is interfered by the environmental noises in transmission, the distance of transmission is short and the speed of transmission is slow. The actuators used in conventional control valves partially use the panel board actuator design.

Since the conventional single chip control valve actuator does not have an embedded Internet integrated chip, it cannot have the advantage of Internet dispersed control.

ROC patent publication No. 223,400 discloses an apparatus of a commercial PC into an industrial network node controller, characterized in that it utilizes note controllers to compose various industrial network node controllers of an apparatus, wherein each node controller performs individual monitoring functions so as to achieve the object of dispersed control, its network comprising: a monitoring host computer which can be an industrial computer or a personal computer and can connect to all node controllers so as to provide information; a host node network controller which can utilize various buses or communication networks to connect to the host computer and a plurality of branch node controllers; a plurality of branch node controllers having monitoring functions; peripheral apparatuses; node controllers that can also be connected to peripheral apparatuses and to share the resource of the computer; each commercial personal computer being converted to an industrial network node controller and constructed to be a dispersed network control so as to composite said apparatus.

However, the disadvantage of the main node network controller of ROC patent publication No. 223,400 is that it can only use various buses or communication networks to connect to the monitoring computer and a plurality of branch node controllers.

ROC patent publication No. 280,883 discloses a dispersed control system, comprising: a control rooms to provide the main control of the dispersed control system; a plurality of network in-situ apparatuses, said apparatuses performing a functional set together and each network in-situ apparatus comprising a main control network port; a control system coupled to each main control network port of each network in-situ apparatus of said plurality of network in-situ apparatuses; a controller coupled to said control room so as to control and provide a main access to said plurality of network in-situ apparatuses, said controller not being able to access a functional subset of said functional set; network/controller connecting apparatuses which connect control network to the controller; and a functional subset access apparatus which provides access to said functional subset.

However, the disadvantage of ROC patent publication No. 280,883 is that it has to provide: a control room to provide the main control of a dispersed control system; a plurality of network in-situ apparatuses, each network in-situ apparatus having a main control network port; and a control network coupled to each main control network port of each network in-situ apparatus of a plurality of network in-situ apparatuses.

U.S. Pat. No. 5,764,891 discloses a transfer apparatus of a process control system which uses FIELDBUS communication protocol and I/O read/write setup in communication with terminal equipments such as industrial control apparatus equipments (e.g., fluid meters, pressure difference transmitters and temperature meters). Adjustment will be done according to the setup feedback when the control I/O sends out instructions and the industrial control apparatus equipments receive instructions.

However, the disadvantage of US patent publication U.S. Pat. No. 5,764,891 is that it can only use FIELDBUS communication protocol host node network controller to couple to the process control loop which only comprises a single loop control circuit.

U.S. Pat. No. 5,825,664 discloses an intelligent control unit comprises control units, sensor units and adjustment units which uses twisted lines as signal transmitting lines. When the sensor unit senses variation, transfers signals to the control unit and instructs with programs. When the adjustment unit receives signals and performs adjusting feedback control, it can be applied to liquid, gas or electromagnetic mechanism process control.

However, the disadvantage of U.S. Pat. No. 5,825,664 is that is can only be a single closed-loop control circuit.

ROC patent publication No. 362,193 discloses a dispersed process control system, comprising: a plurality of taps on the tapping locations, each performs selected functions; a main data bus which loads data; an apparatus which connects said parallel taps to the bus so as to make sure that the data of the selected functions performed by each tap can transfer to and being received by the remaining taps of said plurality of taps and a tap which controls a sequential process operation.

However, the disadvantage of ROC patent publication No. 362,193 is that it has to use a main data bus to load data and an apparatus which connects said parallel taps to the bus so as to make sure that the data of the selected functions performed by each tap can transfer to and being received by the remaining taps of said plurality of taps and a tap which controls a sequential process operation.

ROC patent publication No. 453,068 discloses a network control apparatus for connecting a network device to the Internet through a transmission line. Said apparatus comprises at least: a network device with wire for connecting a plurality of computers; a wireless network device for connecting a plurality of network digital boards; a bridging devices for connecting said network apparatus with said wireless network device so as to form a local network; and an out-connecting device for connecting said local network to the Internet.

However, the disadvantage of ROC patent publication No. 453, 068 is that said network control apparatus has to use a network device to connect to the Internet through a transmission line.

U.S. Pat. No. 6,370,448 discloses a process apparatus coupled to a process control loop, comprising: an interface circuit coupled to a control loop so as to provide the read/write/control and data transmission circuit; a loop interface circuit set up to receive the package data comprising Internet address and network transmission package data address from the process control loop.

U.S. Pat. No. 6,370,448 uses FIELDBUS communication protocol using I/O read and write setup in communication with industrial control apparatus equipment such as fluid meters, differential pressure transmitters and temperature meters. When the control I/O sends out instructions, the industrial control apparatus equipment follows setup feedback to do the adjustment after receiving the instructions. The patent couples industrial process apparatuses to process control loop with FIELDBUS communication protocol and couples to communication control loop with Internet communication protocol through control room.

However, the disadvantage of U.S. Pat. No. 6,370,448 is that it can only use FIELDBUS communication protocol to couple to process control loop and has to provide a control room to couple to communication process control loop with Internet communication protocol.

### SUMMARY OF THE INVENTION

The present invention provides a valve actuator which has an embedded integrated chip. Said valve actuator can connect to the Internet directly so as to achieve the object of dispersed control.

The valve actuator provided by the present invention does not need to use dual twisted lines as the signal transmitting lines.

### BRIEF DESCRIPTION OF THE DRAWINGS

This invention will be better understood with reference to the accompanying drawings in which:

FIG. 1 represents the circuit diagram of the embedded Internet integrated chip controlled valve actuator according to the present invention; and

FIG. 2 represents a process control system using an embedded Internet integrated chip controlled valve actuator according to the present invention and being controlled through the Internet.

### DETAILED DESCRIPTION OF THE INVENTION

The preferred embodiment of the present invention will be described below with reference to the accompanying drawings. The same element in the drawings is represented with the same reference numeral.

Along with the rapid development of the electronic techniques and the networks, the control apparatus is improved to be the embedded Internet integrated chip. The embedded Internet integrated chip is not only smaller in size, but also has improved functions and is lower in price.

The most important feature is that the present invention can use the Internet to control process equipments, to track the current status including remote monitoring in order to get rid of malfunctions, and to further reduce operation cost and raise product ability.

Due to the popularity of the Internet and the improvement of the process ability and the speed of the chip, the network actuator is generated in combination with Transmission Control Protocol/Internet Protocol (TCP/IP) communication protocol techniques. More efficient dispersed control is developed from the conventional centralized control. The actuator is remote-controlled by and connected to the Intranet and the automatic system using the computer through the Internet.

The protocol can send the data to the destination through every possible path as long as the Internet exists. The dispersed control management is achieved by way of monitoring in-situ equipments and data storage of operation and maintenance through the Internet.

Since the Internet is widely spread in the office buildings and the manufacturing systems, the embedded Internet integrated chip controlled valve actuator can be applied to the air conditioning tube control valve of the buildings and tube control valve of the manufacturers.

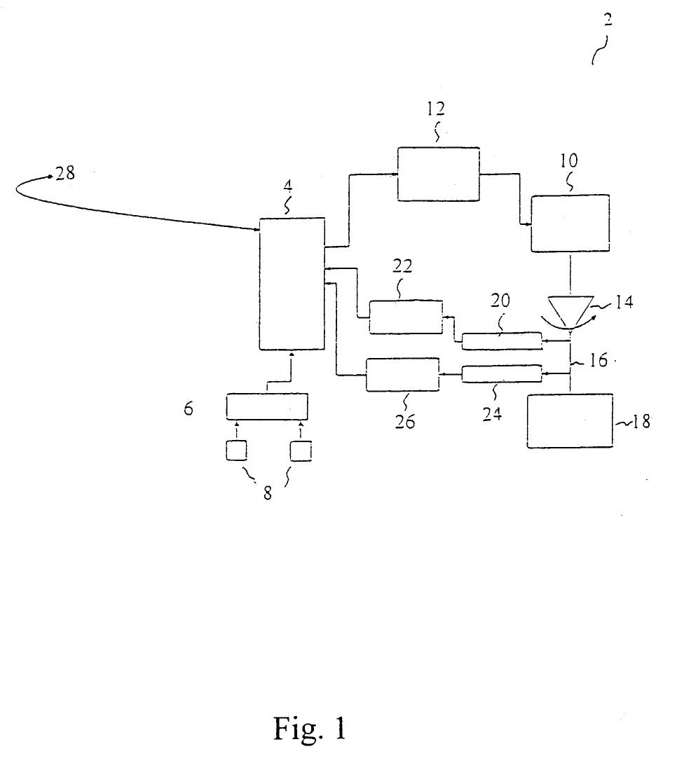

FIG. 1 represents the preferred embodiment of the present invention. An embedded Internet integrated chip controlled valve actuator 2 is shown in the figure according to the present invention, comprising: an embedded Internet integrated chip 4 coupled to a local Ethernet 28 so as to transmit signals with the user equipments (34, 36, 37 and 38, as shown in the figure); a power circuit coupled to said embedded Internet integrated chip, said power circuit being coupled to alternative current/direct current power source so as to provide the power needed by the embedded Internet chip, said power circuit comprising an analog/digital (A/D) digital/analog (D/A) circuit for the usage of an angle input/output and being coupled to a motor control circuit 12; a motor control circuit 12 which is used for receiving signals transmitted by said embedded Internet integrated chip 4 to control a motor 10; a motor 10 which is used to receive the control signal output from the motor control circuit 12 so as to control the clockwise or counterclockwise rotation; a gear box 14 connected to the motor 10 which is used as a deceleration mechanism; an axis 16 connected to the gear box 14, used to rotate a transporting mechanism 18; a transporting mechanism 18 used to adjust a valve (transporting mechanism 18) of a tube; a position sensor 20 coupled to said axis 16 which is used to sense the position of said axis 16; a sensor input/output circuit 22 coupled to said position sensor 20 which is used to receive a signal outputted from said position sensor 20 and transmit said signal to said embedded Internet integrated chip 4; a torque sensor 24 coupled to said axis 16 which is used to sense the torque of said axis 16; and a torque sensor input/output circuit 26 coupled to said torque sensor 24 which is used to receive a signal outputted from said torque sensor 24 and transmit said signal to said embedded Internet integrated chip 4.

The embedded Internet integrated chip controlled valve actuator 2 disclosed by the present invention said serial ports. Said serial ports directly support the access of a Direct Access Memory (DMA). In other words, said serial ports can access memory data directly without being controlled by a central processing unit (CPU). And the transmission rate is generated independently, that is, it can be determined by the programs.

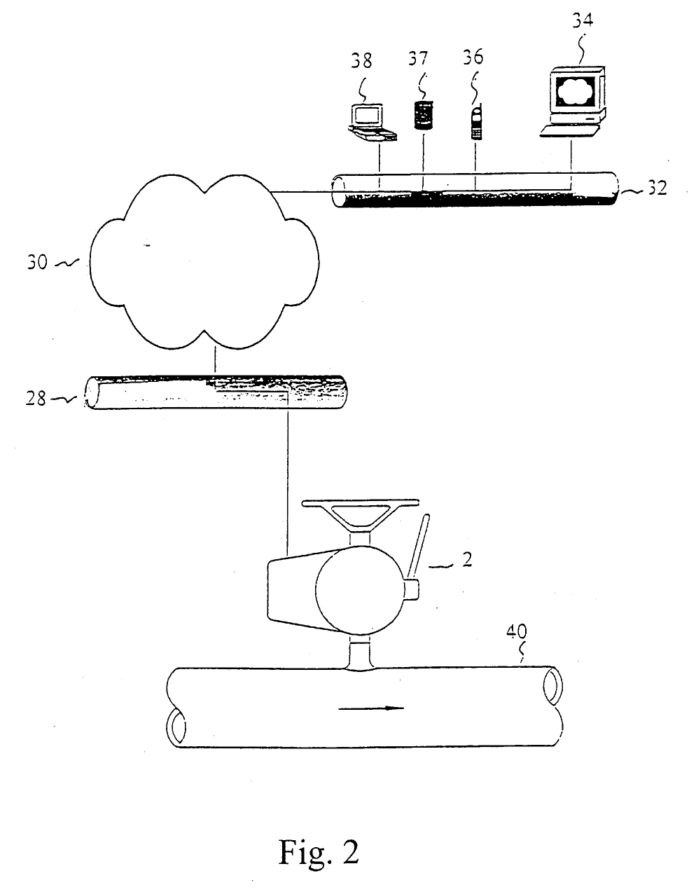

FIG. 2 represents a process control system with an embedded Internet integrated chip controlled valve actuator 2 according to the present invention which is connected the network user ends (such as a personal computer 34, a mobile phone 36 and a notebook 38) and controls the flow rate of the fluid in a tube 40 through the Internet 30 and the local Ethernets 28 and 32. As shown in the figure, the embedded Internet integrated chip controlled valve actuator 2 is used to control the flow amount of the fluid in the tube 40 through a local Ethernet 28 which is coupled to the Internet 30. And the network user end such as a personal computer 34, a mobile phone 36, a PDA 37 or a notebook 38 is coupled to the Internet 30 through another Ethernet 32.

The embedded Internet integrated chip controlled valve actuator 2 of the present invention can work independly as a control unit. In other words, it can be an independent protocol address (IP address) Internet single chip computer control unit and to achieve the object of dispersed control by way of being coupled to the Internet 30 and to transmit a signal. The network user ends include personal computers 34, mobile phones 36, PDAs 37 and notebooks 38 and the user's level is programmable to be administrators and clients.

The object of the dispersed control system of the present invention not only is to establish information link system and to enforce the safety of the operation of the tube 40, but also can set up self-monitoring loop by programs, feedback the utilization condition of the control valve rapidly and monitor the abnormal status of the tube at any time so as to avoid the accidents.

According to IEEE802.3 network protocol, the integrated Ethernet can perform the parity detection and calibration automatically. There is a built-in front position loss resistor which avoids signal loss when applied in the Ethernet network, and has loop diagnosis ability and a collision noise reducing receiver.

With the above descriptions, it is obvious that the embodiments and description are not intended to limit the invention. The invention may be varied in many ways. Such variations are not to be regarded as a departure from the spirit and scope of the invention, and such modifications would be obvious to one skilled in the art and fall within the scope of the following claims.

What is claimed is:

1. An embedded Internet integrated chip controlled valve actuator coupled to a user equipment and controls a flow rate of a fluid in a tube through the Internet and a transmission signal of said user equipment, comprising:
an embedded Internet integrated chip coupled to the Internet so as to transmit signals with said user equipment, to receive a power signal output from a power circuit, to receive output signals from a position sensor input/output circuit and a torque sensor input/output circuit and to transmit a control signal to a motor control circuit;
a power circuit coupled to said embedded Internet integrated chip, wherein said power circuit power circuit is coupled to an alternative current/direct current power source so as to provide the power needed by said embedded Internet chip;
an analog/digital and digital/analog control circuit comprising an analog/digital circuit for the usage of an angle input/output;
a motor control circuit for receiving said control signal transmitted by said embedded Internet integrated chip so as to control a motor, wherein said motor is used for receiving said control signal outputted from said motor control circuit so as to control its clockwise/counterclockwise rotation;
a gear box is connected to said motor and is used as a deceleration mechanism;
an axis connected to said gear box and is used for rotating a transporting mechanism;
a transporting mechanism used for adjusting a valve of a tube so as to control the flow rate of a fluid in said tube;
a position sensor coupled to said axis and is used to sense the position of said axis;
a position sensor input/output circuit coupled to said position sensor and used to receive a signal outputted from said position sensor and to transmit said signal to said embedded Internet integrated chip;
a torque sensor coupled to said axis and used to sense the torque of said axis; and
a torque sensor input/output coupled to said torque sensor and used to receive a signal outputted from said torque sensor and to transmit said signal to said embedded Internet integrated chip.

2. The embedded Internet integrated chip controlled valve actuator as claimed in claim 1, wherein said embedded Internet integrated is according to IEEE802.3 network protocol and transmission control protocol/Internet protocol (TCP/IP) so as to transmit signals with said user equipment through the Internet.

3. The embedded Internet integrated chip controlled valve actuator as claimed in claim 2, wherein said user equipments comprise personal computers, mobile phones, PDAs and notebooks.

4. The embedded Internet integrated chip controlled valve actuator as claimed in claim 3, wherein the levels of said user equipments are programmable to be administrators and clients.

5. The embedded Internet integrated chip controlled valve actuator as claimed in claim 2, wherein said embedded Internet integrated chip controlled valve actuator can work independently as an independent protocol address (IP address) Internet single chip control unit.
